(19) United States
(12) Patent Application Publication
(10) Pub. No.: US 2026/0342004 A1
(43) Pub. Date: Oct. 29, 2026

(54) CONNECTION DEVICE

(71) Applicant: Weidmüller Interface GmbH & Co. KG, Detmold (DE)

(72) Inventors: Thorsten FEIGE, Bielefeld (DE); Torsten WÜNSCHE, Leopoldshöhe (DE)

(21) Appl. No.: 19/117,761

(22) PCT Filed: May 23, 2024
(86) PCT No.: PCT/EP2023/081193

§ 371 Date: Apr. 2, 2025

(30) Foreign Application Priority Data
Nov. 16, 2022 (DE) 10 2022 130 279.2

(51) Int. Cl. H01R 13/627; H01R 13/518; H01R 13/631; H01R 31/06

(52) U.S. Cl. CPC H01R 13/6275; H01R 13/518; H01R 13/631; H01R 31/06; H01R 2201/20

(57) ABSTRACT

A connection device (1) comprises load connectors (L) and control connectors(S), wherein, in a first position (A), as a coupled position of the connection device (1), all load connectors (L) and all control connectors(S) are connected to one another respectively, wherein, in a second position (B), as a test position of the connection device (1), the load connectors (L) are released from one another and the control connectors(S) are connected to one another, and wherein, in a third position (C), as a decoupled position of the connection device (1), all load connectors (L) and all control connectors(S) are respectively released from one another. The connection device (1) has a base unit (2), a socket unit (3) and a plug unit (4) with respective load connectors (L) and control connectors(S).

The present invention relates to a connection device according to the preamble of claim 1.

Such connection devices are used in different applications in order to connect power contacts to one another and to release them from one another.

A further apparatus unit with corresponding power contacts is pushed onto a base apparatus unit with first power contacts. In addition to the power contacts, additional contacts, e.g. control, data and power supply contacts are frequently connected to one another at the apparatus units. These additional contacts are already connected or contacted in a so-called test position, before the apparatus unit is displaced/shifted into a so-called coupled position. In the coupled position, the power contacts are also connected to one another.

It is thus possible for tests to already be able to be carried out before the coupling position is assumed, for example to check the functions of the apparatus units to be connected to one another.

The power contacts and control, data and power supply contacts are configured as plug-in connectors. Plug-in connectors not only transmit energy and signals, but rather also form interfaces for data transmission. The infrastructures relate not only to the electrical supply with AC voltages and DC voltages, but rather also information technology or other auxiliary media such as control voltages of e.g. 24 V or compressed air. However, optical transmission means, such as fibre optic conductors, can also be present in the plug-in connectors.

Documents EP 1 873 865 A2 and WO 2018/073 016 specify examples of connection and switching devices and plug-in connections.

The known solutions have proven their worth, in principle. A complex structure is viewed as a disadvantage. There is therefore a constant demand for further development, with greater functionality being created along with increased safety, a compact structure, a smaller number of component parts and possibilities for variation. means of the subject-matter of claim 1.

A connection device according to the invention comprises load connectors and control connectors, wherein, in a first position, as a coupled position of the connection device, all load connectors and all control connectors are connected to one another respectively, wherein, in a second position, as a test position of the connection device, the load connectors are released from one another and the control connectors are connected to one another, and wherein, in a third position, as a decoupled position of the connection device, all load connectors and all control connectors are respectively released from one another. The connection device has a base unit, a socket unit and a plug unit with respective load connectors and control connectors.

An advantage of this solution is a simple and compact structure with a small number of component parts. In addition, assembly and replacing or supplementing the units is advantageously simple, to also allow the introduction of new technical solutions.

### Further advantages configurations can be gathered from the remaining subordinate claims.

In one design, in the first position, the power connectors and the control connectors of the base unit are respectively connected to the power connectors and the control connectors of the socket unit and the power connectors and the control connectors of the socket unit are respectively connected to the power connectors and the control connectors of the plug unit, in the second position, the power connectors of the base unit and the power connectors of the socket unit are released from one another, and, in the third position, the power connectors and the control connectors of the base unit and the power connectors and the control connectors of the socket unit are released from one another and the power connectors and the control connectors of the socket unit and the power connectors and the control connectors of the plug unit are released from one another. The division of the connectors, e.g. as inserts in the units, is advantageous, since in this manner not only is a simple fitting and changing of the units possible, but rather it is possible to accomplish simple adoption and division of the various positions. Furthermore, different applications can be accomplished with different connectors.

Thus, a further design envisages that the socket unit and the plug unit are shiftable together out of the first position into the second position in a longitudinal direction of the connection device, wherein the socket unit in the second position is fixed by means of a latching mechanism and the plug unit is shiftable out of the second position into the third position in the longitudinal direction of the connection device. Here, it is advantageous that the shifting of the units, for example, by means of a shiftable component part, e.g. a drawer with a crank, and locking in the positions can be accomplished simply. In addition, there is a particular advantage in that a latching mechanism enables the socket unit to be fixed in the second position.

In another additional design, the plug unit is shiftable out of the third position of the connection device in the longitudinal direction of the connection device back into the second position of the connection device, wherein, when the plug unit is shifted further in the longitudinal direction of the connection device, the socket unit, together with the plug unit, is shiftable out of the second position of the connection device back into the first position of the connection device after the fixing of the latching mechanism is released by means of the plug unit. An advantage here is automatic releasing of the fixing of the latching mechanism by the plug unit, as the number of component parts is thus low.

It is advantageous that the latching mechanism comprises two opposing resilient arms with one lug each, wherein the arms are affixed to the base unit and the lugs interact with stops and recesses on the socket unit and an end wall of a holding section which is connected to the socket unit. In this manner, a compact structure is possible. In addition, it is advantageous that the arms are affixed to the base unit, since in this manner an advantageously simple and effective compliance with, and possible adaptation of, a spacing between the second position (test position) and the first position (coupled position) is achieved.

One design envisages that the resilient arms of the latching mechanism can be actuated by means of inclines of a guiding unit, wherein the guiding unit is attached to the plug unit. This enables an advantageously simple and compact structure.

In a further design, it is advantageous that the latching mechanism is affixed by the arms to the base unit via a guide section, wherein the guide section interacts with the holding section of the socket unit. Thus, an advantageously simple structure is enabled with a small number of parts.

When the holding section is received in the guide section between the arms of the latching mechanism, an upper cover wall and a lower cover wall, this gives an advantageously simple and compact design with high functionality.

In an alternative design, the guide section is displaceably guided in a cover in the longitudinal direction of the connection device and is configured to be latchable in various positions or levels. In this manner, a required spacing of the second position (test position) from the first position (coupled position) can advantageously be set and also altered on-site.

Another design envisages that a guiding protrusion, which extends in the longitudinal direction of the connection device and points to the socket unit, is attached to the guiding unit of the plug unit. Thus, an advantageously simple and secure threading of the connection between the plug unit and the socket unit is achieved.

When the guiding protrusion of the plug unit is configured in the form of a cylindrical pin with a pointed end, advantageously increased security is achieved when connecting the plug unit and the socket unit.

A further advantageous improvement of simplicity and functionality of the connection of the plug unit and socket unit is envisaged by a further design in which a receptacle is arranged on the socket unit and has a circular-cylindrical inner space for receiving the guiding protrusion of the plug unit.

In a further design, the base unit is arranged to be stationary. This is advantageous because in this manner only the socket unit and the plug unit are designed to be movable.

Another further design envisages that the power connectors and the control connectors are plug-in connectors. Thus, component parts that are available in higher quality and inexpensively can advantageously be used. This is also advantageous in the case of maintenance and exchanging.

The connection device according to the invention offers further advantages:
a future-proof and variable solution
easy handling for the customer (latching possibilities of the base unit, socket unit and plug unit to drawers and switch cabinets)
inserts latch into the frame (no screws)
prefabricated cable sets are possible
Data and power transmission possible via inserts
Fewer parts than current solutions on the market (lower costs)
Very small dimensions for the functionality

An exemplary embodiment of the invention will be described below with the aid of the enclosed drawings. This exemplary embodiment serves only to illustrate the invention using preferred constructions which, however, do not, definitively depict the invention. In this regard, other exemplary embodiments, modifications and equivalents of the exemplary embodiment depicted can also be realised within the framework of the claims.

### IN THE DRAWINGS

FIGS. 1-4 show schematic perspective views of an exemplary embodiment of a connection device according to the invention in different positions;

FIGS. 5-11 show schematic plan views of the exemplary embodiment according to FIGS. 1-4 in different positions; and

FIGS. 12-16 show schematic perspective views of different guide sections of base units.

Coordinates x, y, z are specified for the purposes of better orientation.

The terms “top”, “bottom”, “left” and “right” relate to the respective arrangement of the component parts in the figures.

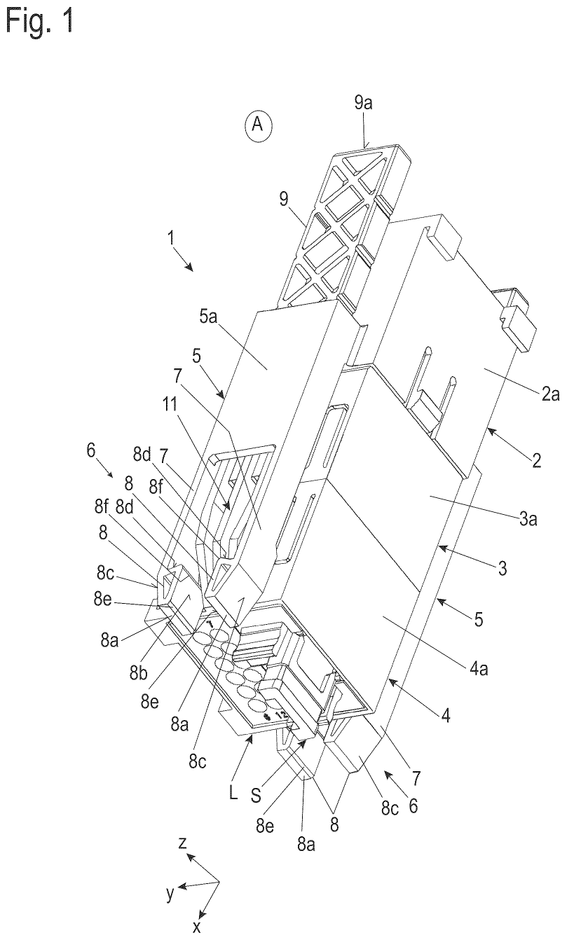

FIG. 1 shows a schematic perspective view of an exemplary embodiment of a connection device 1 according to the invention in a first position A (coupled position).

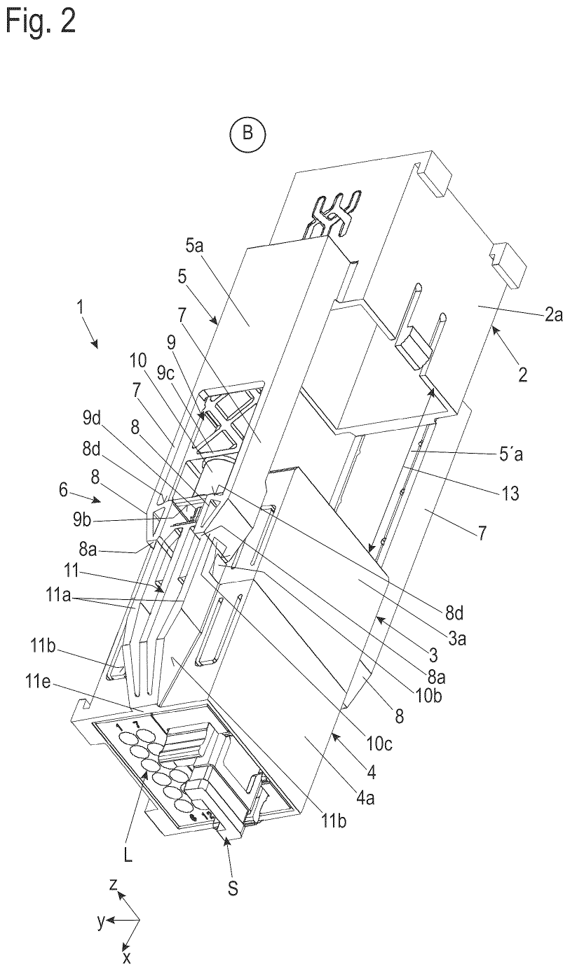

FIG. 2 depicts a schematic perspective view of the exemplary embodiment according to FIG. 1 in a second position B (test position).

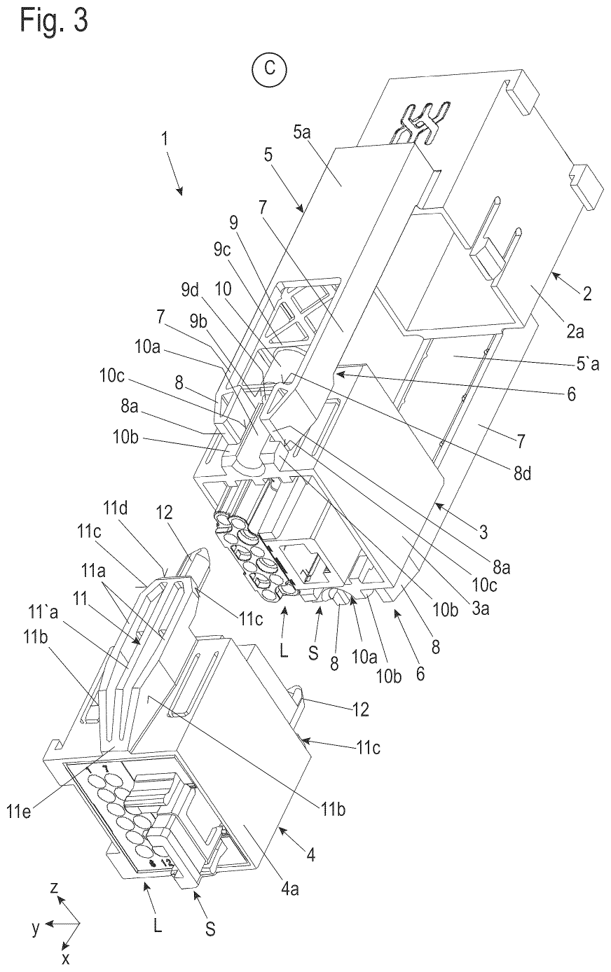

FIG. 3 depicts a schematic perspective view of the exemplary embodiment according to FIG. 1 in a third position C (decoupled position).

The coordinate x runs in a longitudinal direction of the connection device 1, with the coordinate y lying in a width direction and the coordinate z lying in a height direction of the connection device 1.

### The connection device 1 includes a base unit 2, a socket unit 3 and a plug unit 4.

The term “to the front”, “forwards” or “front” refers to the side of the circuit breaker 1 towards which the movable units 3 and 4 of the circuit breaker 1 are moved away from the fixed base unit 2 in the positive x direction. Moving the units 3 and 4 together in the negative x direction towards the fixed base unit 2 characterises the terms ‘behind’, ‘to the rear’.

The base unit 2 has a base frame 2a, with which it is affixed to a fixed component part, e.g. a switch cabinet. This affixing can, for example, be realised by means of latching and/or clipping connections for quick and easy installation.

Similarly, the socket unit 3 is provided with a socket frame 3a. The plug unit 4 also has a frame, which is labelled here as plug frame 4a.

The base frame 2a, the socket frame 3a and the plug frame 4a are each configured here with a surrounding wall, which defines a respective continuous inner space, having a rectangular cross-section in this case. The outer dimensions of the frames 2a, 3a, 4a are essentially the same size.

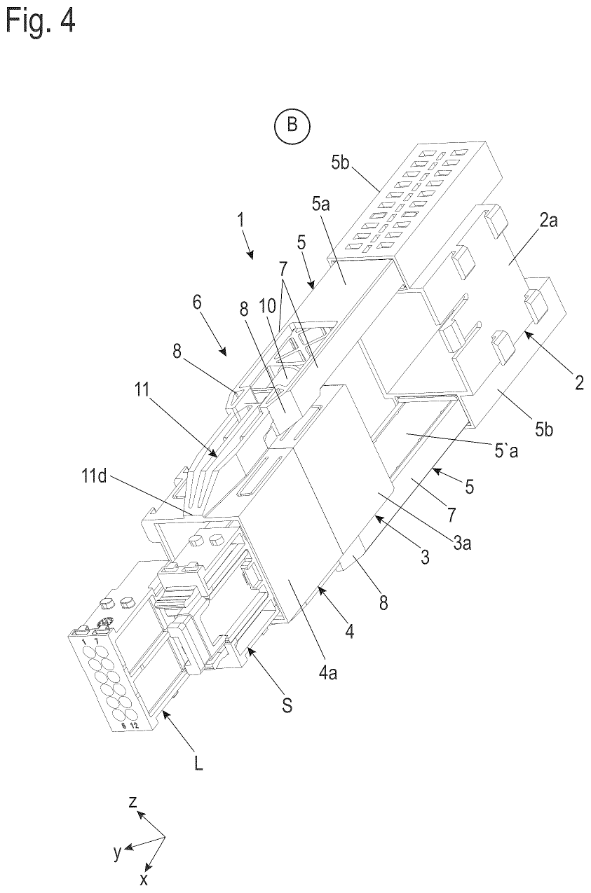

The inner spaces of the frames 2a, 3a, 4a each serve to receive standardised inserts (e.g. HDC inserts), which can be inserted into the respective frames 2a, 3a, 4a and latched or clipped or otherwise affixed, depending on the previously definition. For this purpose, FIG. 4 shows a schematic perspective view of the exemplary embodiment according to FIG. 1 in the first position A (coupled position) with inserts of load connectors L and control connectors S, on the plug part 4 for example.

In FIGS. 1, 2, 3, these inserts are shown by way of example as load connectors for a load string and as control connectors S for a control string of the connection device 1. The control string S is a data or basic services string.

Other future connectors, which are not shown, e.g. for communication solutions, can also be used. These give maximum flexibility and different functionality. inserts are coupled in such a way that both the control string is coupled by the control connectors S and the load string is coupled by the load connectors L. This means that the load connectors L of the base unit 2, the load connectors L of the socket unit 3 and the load connectors L of the plug unit 4 are connected to one another. Likewise, in the first position A, the control connectors S of the base unit 2, the control connectors S of the socket unit 3 and the control connectors S of plug unit 4 are also connected to one another.

In a second position B (test position), the load connectors L of the socket unit 3 and the load connectors L of the plug unit 4 are still connected to one another, but they are no longer connected to the load connectors L of base unit 2. The load string with the load connectors L is therefore interrupted. However, the control connectors S of the base unit 2, the control connectors S of the socket unit 3 and the control connectors S of the plug unit 4 remain connected to one another.

And in a third position C (decoupled position), both all load connectors L of the load string and all control connectors S of the control string are no longer respectively connected to one another. Thus, in this position C, both the load string and the control string are interrupted.

The socket unit 3 and the plug unit 4 are in operative connection with a component part (not shown), e.g. a drawer, in the associated control cabinet with its respective frame 3a, 4a, this component part being movable in the longitudinal direction of the connection device 1. This operative connection is designed in such a way that the plug unit 4 is firmly connected to the drawer and that, during a movement from the first position A to the second position B, the socket unit 3 is coupled to the drawer until the socket unit 3 has reached the second position B. During a further movement of the drawer with the plug unit 4 from the second position B to the third position C, the coupling between the socket unit 3 and the drawer is cancelled.

If the plug unit 4 is moved in the negative x-direction, i.e. when the connection device 1 is closed, from the third position C to the second position B, the socket unit 3 is then carried along from the second position B by the plug unit 4 in the direction of the base unit 2 into the first position A. Here, the previously released coupling between the drawer and the socket unit 3 can be re-established, e.g. by means of a mechanical changeover switch. Of course, other carry-along mechanisms are also possible.

In this manner, the socket unit 3 and the plug unit 4 are shifted together, starting in the first position A (coupled position, see FIG. 1) in the x-direction into the second position B (test position, see FIG. 2) with the drawer, whereby the base unit 2 remains stationary in its position, i.e. in position B.

When the drawer is shifted further, the socket unit 3 remains in the second position B (test position) which it has taken up, and only the plug unit 4 is shifted from there into the third position C (decoupled position, see FIG. 3) by means of the drawer.

In this manner, the plug unit 4 of the connection device 1 is shifted out of the first position A (coupled position) into the second position B (test position) and from there into the third position C (decoupled position) and back again.

The socket unit 3 is only shifted out of the first position A (coupled position) into the second position B (test position) and back again from there.

It is also possible that once the second position B (test position) has been assumed, the plug unit 4 can be shifted back to the first position A (coupled position) with the socket unit 3 again, without the third position C (decoupled position) being assumed.

The drawer can be shifted, for example by means of a crank that is not shown but which can be easily envisaged. The drawer of the connection device 1 is locked in each of the aforementioned three positions A, B, C. To shift the drawer, the lock must be unlocked by means of manual actuation, and only then can the next position A, B, C be assumed by shifting the drawer with the crank.

The connection device 1 has a latching mechanism 6. The latching mechanism 6 locks or fixes the socket unit 3 in the second position B (test position).

The latching mechanism 6 is affixed to the base unit 2 via a guide section 5. In the example shown, two latching mechanisms 6 are provided, namely one on the upper side of the frame 2a of the base unit 2 and one on the underside of the frame 2a of the base unit 2.

The latching mechanism 6 comprises two opposing resilient arms 7, each with a lug 8 at the respective free end of an arm 7. The arms 7 extend parallel to one another in the x-direction over the upper sides and undersides of the socket unit 3 and plug unit 4 and protrude in the z-direction in an x-z plane from the upper side and underside of the socket unit 3 respectively.

The arms 7 are resiliently deflected in the y-direction.

In the first position A (coupled position, FIG. 1), the free ends of the arms 7 protrude, by the lugs 8, in the positive x-direction over the respective front rim of the upper side and underside of the plug frame 4a of the plug unit 4.

The resilient arms 7 are relaxed in the first position A (coupled position) in order to prevent relaxation of the material of the resilient arms 7.

The other ends of the arms 7, i.e. their rear ends, which point towards the base unit 2, are each affixed onto the upper side and the underside of the base frame 2a of the base unit 2 in a front region of the base frame 2a. The front region should be understood to be the end face of the base frame 2a, which points towards the socket unit 3.

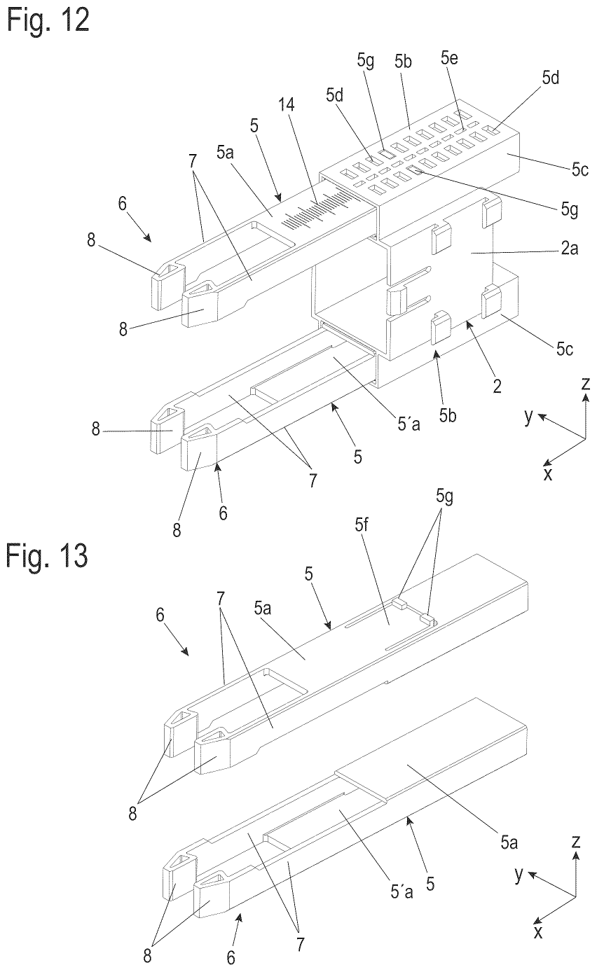

Starting from the other ends of the arms 7, these are connected on their upper sides to an upper cover wall 5a and between their undersides to a lower cover wall 5′a, whereby the upper cover wall 5a extends over approximately half the length and the lower cover wall 5′a extends slightly further than the upper cover wall 5a in the x-direction of the arms 7. This can be seen clearly in FIGS. 12, 13.

The cover walls 5a, 5′a of the guide section 5 and the sections of the arms 7 connected to them form a receptacle in the form of a rectangular tube of a guide section 5 (see e.g. FIGS. 12-13), which serves to displaceably receive a holding section 9 of the socket unit 3.

In the example shown, two holding sections 9 are provided, of which respectively one holding section 9 is affixed to an upper side and one to an underside of the socket unit 3. The description of the holding section 9 applies to both holding sections 9.

The holding section 9 is box-shaped with a rear end wall 9a and a front end wall 9b and corresponds in its width and height to the dimensions of the arms 7 and the guide section 5. The holding section 9 can be solid and/or be configured with reinforcing ribs.

In the first position a (coupled position, FIG. 1), a front section of the holding section 9 is pushed inside the guide section 5, as the socket unit 3 is coupled to the base unit 2.

Here, the rear, longer part of the holding section 9 is shifted over the upper side (or underside) of the base frame 2a and protrudes on the rear side of the base frame 2a in the x-direction.

A receptacle 10 is arranged between the front end wall 9b of the holding section 9 and a partition wall 9c of the holding section 9 (see FIGS. 2 and 3). The receptacle 10 has a circular-cylindrical inner space with an aperture 9d in the front end wall 9b for receiving a guiding protrusion 12 of the plug unit 4, which will be explained in more detail below.

A semi-circular support 10a for supporting the guiding protrusion 12 of the plug unit 4 adjoins the front end wall 9b towards the front.

An upwardly projecting stop 10b is moulded in each case onto the front end of the support 10a on both sides of the support 10a. A recess 10c is moulded in each case between the stops 10b and the front end wall 9b of the guide section 9.

The holding section 9 is attached with its front end in the region between the partition wall 9c, the receptacle 10, the support 10a and the stops 10b on the upper side and underside of the socket frame 3a of the socket unit 3.

The recesses 10c each form a receptacle for a respective lug 8 of the latching mechanism 6 when the socket unit 3 is in the second position B (test position). This will be explained in detail below.

Each lug 8 comprises an end face 8a, an inner side 8b running essentially straight in the x-direction, an external incline 8c, a stop section 8d, a front chamfer 8e and a rear chamfer 8f.

The external incline 8c of the lug extends as a front end section of the arm 7 folded inwards around the z-coordinate, i.e. to an imaginary longitudinal centre line of the holding section 9 between the arms 7, and ends at the end face 8a. Starting from the end face 8a, the inner side 8b extends in the negative x-direction up to the stop section 8d. The stop section 8d connects the rear end of the inner side 8b to the arm 7 in the region of the bend of the external incline 8c. The stop section 8d is bent forward at a slight incline.

The front chamfer 8e is arranged between the front end face 8a and the inner side 8b.

The rear chamfer 8f is moulded onto the connection to the stop section 8d at the rear edge of the inner side 8b.

When the socket unit 3 is in the second position B (test position, FIG. 2), the lugs 8 of the latching mechanism 6 are pressed into the respective recesses 10c by the spring force of the arms 7 and are received therein (see e.g. FIGS. 2 and 3).

The end face 8a of the lug 8 is in contact with the front stop 10b. Furthermore, the rear stop section 8d of the lug 8 is in contact with the end face 9b of the holding section 9. In this manner, the lugs 8 of the arms 7 of the latching mechanism 6 are received by their inner sides 8b in the recesses 10c between the respective stops 10b and the end face 9b and block or fix the socket unit 3 in this second position B (test position) in the x-direction, i.e. in the longitudinal direction of the connection device 1.

The holding section 9 is shiftably received in the guide section 5 between the arms 7 and the upper cover wall 5a and the lower cover wall 5′a.

In the second position B (test position, FIG. 2) and also in the third position C (decoupled position, FIG. 3), a certain spacing 13 is formed between the base unit 2 and the socket unit 3. This spacing 13 is necessary because the second position B (test position) must establish an electrical connection of the control connectors S exactly in this spacing 13 (e.g. 45 mm) before the final position A (coupled position).

In the third position C (decoupled position), which is depicted in FIG. 3, the plug unit 4 is pulled out of the socket unit 3, with the socket unit 3 remaining held or fixed in its position B by the latching mechanism 6.

The plug unit 4 has at least one guiding unit 11. In the example shown, two guiding units 11 are provided, one of which is attached to the top of the plug frame 4a. The second guiding unit 11 is located on the underside of the plug frame 4a. The description of the first guiding unit 11 also applies to the second guiding unit 11.

The guiding unit 11 protrudes from the plug frame 4a in the z-direction and to the rear over the rear rim of the plug frame 4a in the negative x-direction.

Here, each guiding unit 11 has two outer walls 11a and a central, inner wall 11′a. The two outer walls 11a are each provided, in the front region, with an incline 11b, which runs approximately from a central region of the plug frame 4a to the middle wall 11′a.

In that rear region of the guiding unit 11 which juts out beyond the rim of the plug frame 4a, the end regions of the two outer walls 11a are also each provided with an incline 11c. Both the inclines 11b in the front area and the inclines 11c in the rear area run towards each other.

The free ends of the rear inclines 11c are connected to a rear end section 11d, with the free ends of the front inclines 11b being connected to a front end section 11e.

Furthermore, in the rear area of the guiding unit 11, which juts out beyond the rim of the plug frame 4a, a guiding protrusion 12 is attached below the rear end section 11d. The guiding protrusion 12 is configured here in the form of a cylindrical pin with a pointed end and extends in the negative x-direction in the direction of the longitudinal axis of the connection device 1.

In the second position B (test position, FIG. 2) and also in the first position A (coupled position, FIG. 1), the plug unit 4 is coupled to the socket unit 3. The guiding protrusion 12 of the plug unit 4 extends with a section into the above-described circular-cylindrical inner space of the receptacle 10 of the socket unit 3 through the aperture 9d in the front end wall 9b and is received in the receptacle 10 of the socket unit 3. A further, front section of the guiding protrusion 12 rests in the support 10a of the socket unit 3. The rear end section 11d of the guiding unit 11 is then in contact with the end wall 9b of the holding section 9 of the socket unit 3.

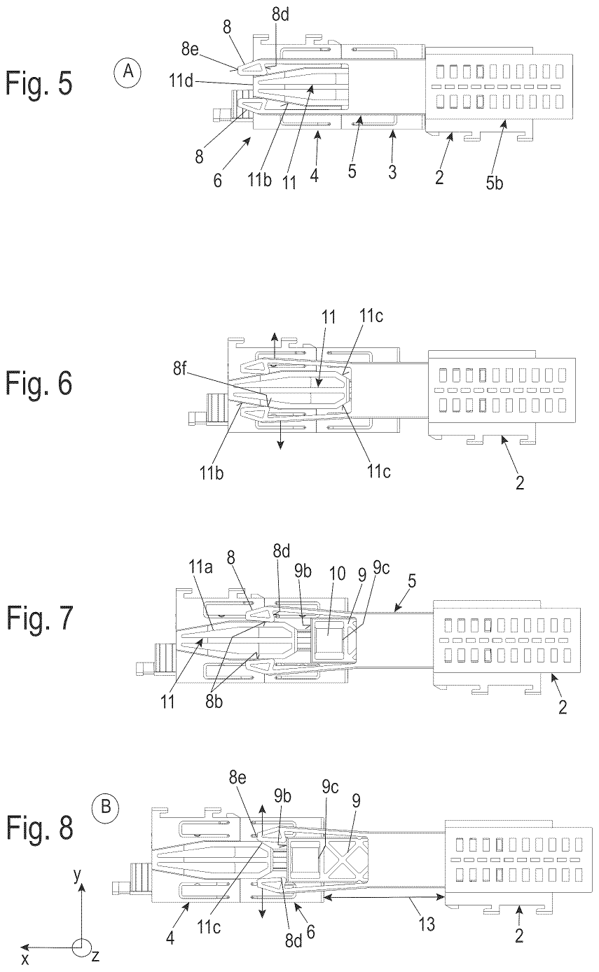

FIGS. 5-11 show schematic plan views of the exemplary embodiment according to FIGS. 1-4 in different positions and intermediate positions.

The order from FIG. 5 to FIG. 11 depicts the units 3 and 4 of the connection device 1 being pulled out or moved apart. The connection device 1 is engaged in the reverse order from FIG. 11 according to FIG. 5.

FIG. 5 shows the first position A (coupled position). The socket unit 3 is coupled to the stationary base unit 2, and the plug unit 4 is coupled to the socket unit 3. The latching mechanism 6 with the arms 7 is relaxed.

When engaging from the first position A (coupled position) into the second position B (test position), the socket unit 3 (load side) is separated from the base unit 2 and the socket unit 3 (control level) is shifted into the second position B (test position) as it passes through the spacing 13 (45 mm). The latching mechanism 6 latches into the recesses 10c of the socket unit 3 and locks it in this position.

In the intermediate position in FIG. 6, the socket unit 3 and the plug unit 4 are a little way away from the base unit 2 in the positive x-direction. The resilient arms 7 of the latching mechanism 6 are spread, i.e. tensioned, in the y-direction. This occurs in that the rear chamfers 8f of the lugs 8 (see FIG. 1) are in contact with the front inclines 11b of the guiding unit 11 of the plug unit 4. During the movement of the plug unit 4 in the positive x-direction, the lugs 8 and thus the arms 7 are moved apart in the y-direction due to the sliding of the rear chamfers 8f on the front inclines 11b.

FIG. 7 shows a further intermediate position in which the lugs 8, by their inner sides 8b, are in contact with the outer walls 11a of the guiding unit 11 (see FIG. 1) and slide along these during further movement.

In FIG. 8, the second position B (test position) is assumed. The socket unit 3 is at the specified spacing 13 from the base unit 2, with the front end chamfers 8e of the lugs 8 being in contact with these at the start of the respective rear incline 11c of the guide unit 11. The arms 7 are still tensioned. At the same time, the rear stop sections 8d of the lugs 8 (see FIG. 2) abut against the front end wall 9b of the holding section 9, which is firmly connected to the socket unit 3, and block any further movement of the socket unit 3 in the positive x-direction. In this manner, the socket unit 3 is fixed in the second position B (test position) in the positive x-direction.

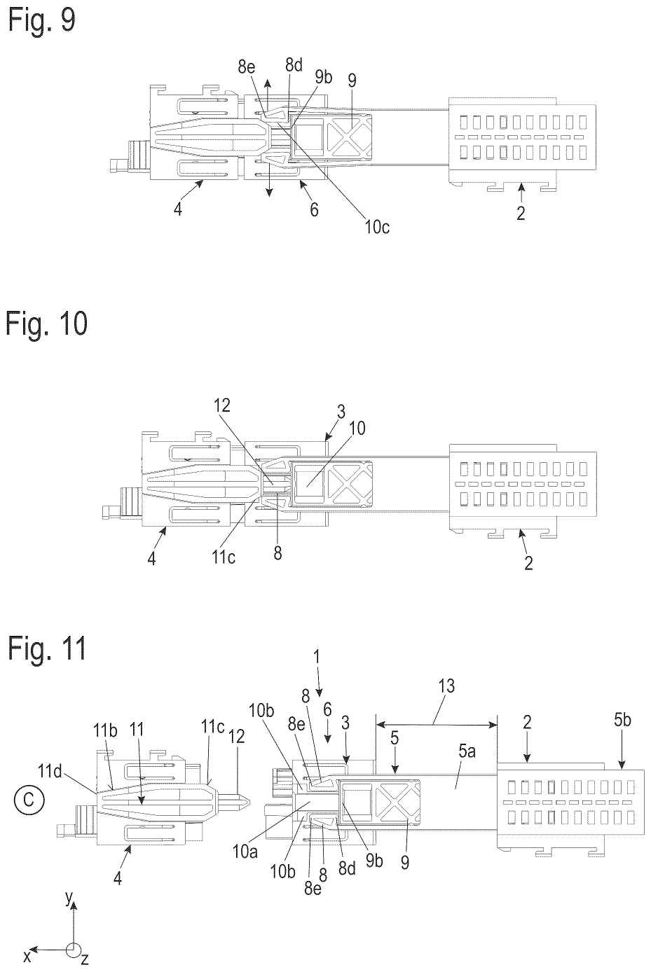

If the plug unit 4 now moves further in the positive x-direction, the socket unit 3 remains fixed in its position by the latching mechanism 6 and the lugs 8 slide with their front chamfers 8e further along the rear inclines 11c of the guide unit 11 (FIG. 9) until the lugs 8 are fully received in the recesses 10c by the spring force of the arms 7 (FIG. 10). The socket unit 3 is thus also locked in the negative x-direction.

Finally, in the third position C (decoupled position), the plug unit 4 is completely removed from the socket unit 3, as shown in FIG. 11. The socket unit 3 continues to remain fixed at the spacing 13 to the base unit by the latching mechanism 6.

In reverse order, starting from the third position C (decoupled position, FIG. 11), the plug unit 4 is moved in the negative x-direction and pushed into the socket unit 3, with the guiding protrusion 12 being threaded over the support 10a through the aperture 9d into the receptacle 10 of the socket unit 3 (FIGS. 10-9-8) and the second position B (test position) is assumed. The socket unit 3 cannot move as it is fixed in position by the latching mechanism 6.

When leaving the second position B (test position, FIG. 8), the arms 7 of the latching mechanism 6 are already levered open by the sliding contact between rear inclines 11c of the guiding unit 11 of the plug unit 4 and the front end chamfers 8e of the lugs 8 of the arms 7. Upon moving further in the negative x-direction, the locking of the socket unit 3 in the negative x-direction is thus cancelled by the spreading of the arms 7 by their lugs 8 (FIGS. 7-6). The plug unit 4 moved by the drawer now pushes the socket unit 3 into the first position A (coupled position) when shifted further in the negative x-direction and the load region is contacted or connected again.

FIGS. 12-14 show schematic perspective views of a variant of the guide section 5 of the base unit 3.

In this variant, in contrast to the design according to FIGS. 1 to 4, the guide section 5 is not firmly attached to the upper side of the base frame 2a of the base unit 2, but rather is guided displaceably in the longitudinal direction (x-coordinate) in a cover 5b and is configured to be lockable in various positions or levels. In this manner, it is possible to set different distances 13 (see e.g. FIGS. 5, 11) on site, e.g. to adapt to different applications.

The description also applies to a second guide section 5 on the underside of the base frame 2a of the base unit 2.

The cover 5b is firmly connected to the base frame 2a of the base unit 2 and has a feed-through aperture with a rectangular cross-section that corresponds to the cross-section of the guide section 5. The feed-through aperture is defined by an upper cover side (not labelled) of the cover 5b, two parallel side walls 5c of the cover 5b and a region of the upper side/underside of the base frame 2a.

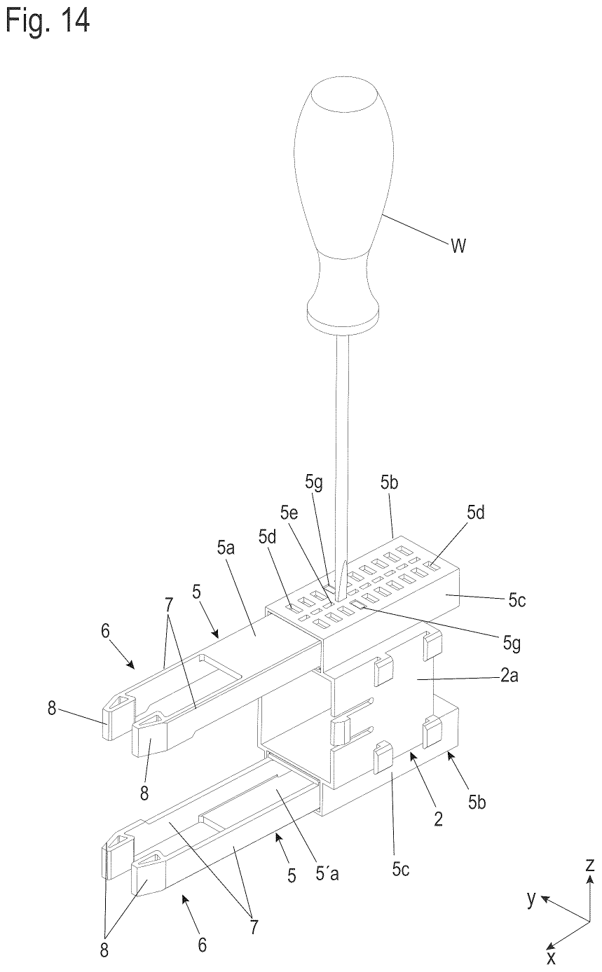

The upper side of the cover 5b has two rows of latching apertures 5d and a central row of shifting apertures 5e. These rows run parallel to one another and in the x-direction. The latching apertures 5d serve to receive protrusions 5g (see FIG. 13), wherein the shifting apertures 5e are provided for the introduction of a tool W (see FIG. 14) for actuating a resilient tongue 5f. The resilient tongue 5f bears the protrusions 5g and is configured as a section of the cover wall 5a here.

The cover wall 5a can also be provided with a scale 14 (see FIG. 12) to set different spacings 13 between the base unit 2 and the socket unit 3 in the second position B (test position).

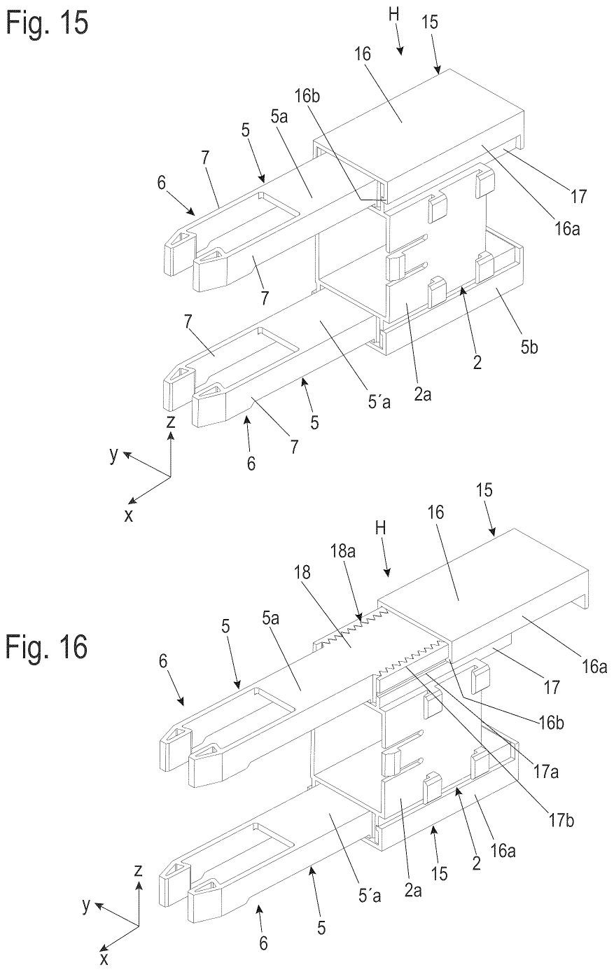

FIGS. 15-16 depict schematic perspective views of an additional variant of the guide section 5 of the base unit 3.

In this variant, the fixing of a shiftable guide section 5 in the direction of the x-axis is accomplished by means of a holding section 18 with a toothing 18a. For this purpose, in the region of the affixing of the guide section 5 to the base frame 2a of the base unit 2, the sides of the arms 7 are provided on each side with a toothing 18a which engages with a corresponding toothing 17b on inner sides of side walls 17 of a fixture H.

To set the spacing 13, the guide sections 5 are lifted out of the toothings 17b in the z-direction and are re-inserted into the toothings 17b between the side walls 17 after the desired spacing 13 has been set. A cover 15 with a cover wall 16 and two parallel side walls 16a is placed onto the side walls 17 of the fixture H, with lateral guide protrusions 16b of the cover 15 come into engagement with guide grooves 17a in the side walls 17. The cover 15 can thus be pushed in the x-direction onto the side walls 17 or clipped on. In this manner, the cover 15 prevents the guide section 5 from being pulled out or falling out of the fixture H in the z-direction.

In an easily envisageable example which is not shown, the spring force of the arms 7 of the latching mechanism 6 in the y-direction can be additionally strengthened by a bracket, for example, being placed/clamped onto the arms 7 and thus in each case holding two arms 7 together in the y-direction.

The inserts of the load connectors L and/or control connectors S can be prefabricated with appropriate electrical/optical wires.

A future-proof and variable solution for a connection device is thus created.

Further advantages are
a future-proof and variable solution
easy handling for the customer (base unit 2, socket unit 3 and plug unit 4 can be easily attached to drawers and switch cabinets, e.g. by latching options)
inserts latch into the frame (no screws)
Prefabricated cable sets are possible
Data and power transmission possible via inserts
Fewer parts than current solutions on the market (lower costs)
Very small dimensions for the functionality
Less wear of the contacts by guiding protrusion 12

The invention is not restricted by the exemplary embodiments described above, but rather can be modified within the framework of the claims.

It is thus conceivable that only one guide section 5 or more than two guide sections 5 are provided with associated latching mechanism(s) 6.

Accordingly, only one holding section 9 maybe also attached to the socket frame 3a of the socket unit 3, or more than two holding sections 9 may also be provided.

It is also conceivable that the plug unit 4 has only one guiding unit 11 or more than two guiding units 11.

In addition, it is also conceivable that the base unit 2 is configured to be movable, i.e. shiftable.

### LIST OF REFERENCE NUMBERS

Connection device 1
Base unit 2
Base frame 2a
Socket unit 3
Socket frame 3a
Plug unit 4
Plug frame 4a
Guide section 5
Cover wall 5 a, 5′a
Cover 5b
Side wall 5c
Latching aperture 5d
Adjusting aperture 5e
Tongue 5f
Protrusion 5g
Latching mechanism 6
Arm 7
Lug 8
End face 8a
Inner side 8b
External incline 8c
Stop section 8d
Front chamfer 8e
Chamfer 8f
Holding section 9
End wall 9a, 9b
Partition wall 9c
Aperture 9d
Receptacle 10
Support 10a
Stop 10b
Recess 10c
Guiding unit 11
Wall 11a, 11′a
Incline 11b, 11c
End section 11d, 11e
Guiding protrusion 12
Spacing 13
Scale 14
Cover 15
Cover wall 16
Side wall 16a
Guiding protrusion 16b
Side wall 17
Guiding groove 17a
Toothing 17b
Holding section 18
Toothing 18a
Position A, B, C
Fixture 18
Load connector L
Control connector S
Tool W
Coordinates x, y, z

1. A connection device (1) having load connectors (L) and control connectors (S), wherein, in a first position (A), as a coupled position of the connection device (1), all load connectors (L) and all control connectors (S) are connected to one another respectively, wherein, in a second position (B), as a test position of the connection device (1), the load connectors (L) are released from one another and the control connectors (S) are connected to one another, and wherein, in a third position (C), as a decoupled position of the connection device (1), all load connectors (L) and all control connectors(S) are respectively released from one another
characterised in that
the connection device (1) has a base unit (2), a socket unit (3) and a plug unit (4) with respective load connectors (L) and control connectors (S).

2. The connection device (1) according to claim 1, characterised in that, in the first position (A), the power connectors (L) and the control connectors (S) of the base unit (2) are respectively connected to the power connectors (L) and the control connectors (S) of the socket unit (3) and the power connectors (L) and the control connectors (S) of the socket unit (3) are respectively connected to the power connectors (L) and the control connectors(S) of the plug unit (4), that, in the second position (B), the power connectors (L) of the base unit (2) and the power connectors (L) of the socket unit (3) are released from one another, and that, in the third position (C), the power connectors (L) and the control connectors (S) of the base unit (2) and the power connectors (L) and the control connectors (S) of the socket unit (3) are released from one another and the power connector (L) and the control connectors (S) of the socket unit (3) and the power connectors (L) and the control connectors (S) of the plug unit (3) are released from one another.

3. The connection device (1) according to claim 2, characterised in that the socket unit (3) and the plug unit (4) are shiftable together out of the first position (A) into the second position (B) in a longitudinal direction of the connection device (1), wherein the socket unit (3) in the second position (B) is fixed by means of a latching mechanism (6) and the plug unit (4) is shiftable out of the second position (B) into the third position (C) in the longitudinal direction of the connection device (1).

4. The connection device (1) according to claim 3, characterised in that the plug unit (4) is shiftable out of the third position (C) of the connection device (1) in the longitudinal direction of the connection device (1) back into the second position (B) of the connection device (1) wherein, when the plug unit (4) is shifted further in the longitudinal direction of the connection device (1), the socket unit (2), together with the plug unit (4), is shiftable out of the second position (B) of the connection device (1) back into the first position of the connection device (1) after the fixing of the latching mechanism (6) is released by means of the plug unit.

5. The connection device (1) according to claim 3 or 4, characterised in that the latching mechanism (6) comprises two opposing resilient arms (7) with one lug (8) each, wherein the arms (7) are affixed to the base unit (2) and the lugs (8) interact with stops (10b) and recesses (10c) on the socket unit (3) and an end wall (9b) of a holding section (9) which is connected to the socket unit (3).

6. The connection device (1) according to claim 5, characterised in that the resilient arms (7) of the latching mechanism (6) can be actuated by means of inclines (11b, 11c) of a guiding unit (11), wherein the guiding unit (11) is attached to the plug unit (4).

7. The connection device (1) according to claim 5 or 6, characterised in that the latching mechanism (6) is affixed by the arms (7) to the base unit (2) via a guide section (5), wherein the guide section (5) interacts with the holding section (9) of the socket unit (3).

8. The connection device (1) according to claim 7, characterised in that the holding section (9) is displaceably received in the guide section (5) between the arms (7), an upper cover wall (5a) and a lower cover wall (5′a).

9. The connection device (1) according to claim 7 or 8, characterised in that the guide section (5) is displaceably guided in a cover (5b) in the longitudinal direction of the connection device (1) and is configured to be latchable in various positions or levels.

10. The connection device (1) according to any one of claims 6 to 9, characterised in that a guiding protrusion (12), which extends in the longitudinal direction of the connection device (1) and points to the socket unit (3), is attached to the guiding unit (11) of the plug unit (4).

11. The connection device (1) according to claim 10, characterised in that the guiding protrusion (12) of the plug unit (4) is configured in the form of a cylindrical pin with a pointed end.

12. The connection device (1) according to claim 11, characterised in that a receptacle (10) is arranged on the socket unit (3) and has a circular cylindrical inner space for receiving the guiding protrusion (12) of the plug unit (4).

13. The connection device (1) according to any one of the preceding claims, characterised in that the base unit (2) is arranged to be stationary.

14. The connection device (1) according to any one of the preceding claims, characterised in that the power connectors (L) and the control connectors(S) are plug-in connectors.
